(19) United States
(12) Patent Application Publication
(10) Pub. No.: US 2016/0238197 A1
(43) Pub. Date: Aug. 18, 2016

(54) Ornamental Lamp with Energy-Saving Function

(71) Applicant: Qing Xie, Anxiang County (CN)

(72) Inventor: Qing Xie, Anxiang County (CN)

(21) Appl. No.: 14/754,780

(22) Filed: Jun. 30, 2015

(30) Foreign Application Priority Data
Feb. 14, 2015 (CN) 201520106314.X

(51) Int. Cl. F21K 99/00

(52) U.S. Cl. CPC F21K 9/1355; F21W 2121/00

(57) ABSTRACT

An ornamental lamp includes a bulb, a base securely connected with the bulb to form a hollow housing, a PCB secured in the base, at least one LED mounted on and electrically connected with the PCB, a stem securely connected with the PCB. The PCB is located under the at least one LED. The stem is provided with a plurality of stripes. Thus, the ornamental lamp supplies a cold light source with little electric power so that the ornamental lamp is operated safely and can reduce consumption of energy.

### BACKGROUND OF THE INVENTION

1. Field of the Invention

The present invention relates to a lighting fixture and, more particularly, to an ornamental lamp.

2. Description of the Related Art

A conventional ornamental lamp comprises a base, a bulb connected with the base, a tungsten filament mounted in the bulb, and a filament support mounted on the base to support the tungsten filament. After the ornamental lamp is energized, the tungsten filament is activated to emit yellow light beams outward so as to provide a decorative effect, thereby enhancing the aesthetic quality of the ornamental lamp. However, the tungsten filament consumes a larger electric power so that the conventional ornamental lamp is not operated safely and cannot save the energy.

### BRIEF SUMMARY OF THE INVENTION

The primary objective of the present invention is to provide an ornamental lamp with an energy-saving function.

In accordance with the present invention, there is provided an ornamental lamp comprising a bulb, a base securely connected with the bulb to form a hollow housing, a PCB secured in the base, at least one LED mounted on and electrically connected with the PCB, a stem securely connected with the PCB. The PCB is located under the at least one LED. The stem is provided with a plurality of stripes.

Preferably, the stem is made of transparent material.

Alternatively, the stem is made of plastic material.

Alternatively, the stem is made of colorful transparent material.

Preferably, the stem has a sheet shape.

Preferably, the stem is a cross-shaped column.

Alternatively, the stem is a multi-prismatic column.

Preferably, the ornamental lamp comprises multiple LEDs.

According to the primary advantage of the present invention, the ornamental lamp supplies a cold light source with little electric power so that the ornamental lamp is operated safely and can reduce consumption of energy.

According to another advantage of the present invention, the stem is made of transparent material with a photoconductive feature, and the stripes of the stem have different reflectivity to simulate the ornamental effect of the tungsten filament, thereby enhancing the aesthetic quality of the ornamental lamp, and thereby decreasing the cost of fabrication.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an ornamental lamp in accordance with the preferred embodiment of the present invention.

FIG. 2 is a perspective view of an ornamental lamp in accordance with another preferred embodiment of the present invention.

FIG. 3 is a perspective view of an ornamental lamp in accordance with another preferred embodiment of the present invention.

FIG. 4 is a perspective view of an ornamental lamp in accordance with another preferred embodiment of the present invention.

FIG. 5 is a perspective view of an ornamental lamp in accordance with another preferred embodiment of the present invention.

FIG. 6 is a perspective view of an ornamental lamp in accordance with another preferred embodiment of the present invention.

FIG. 7 is a perspective view of an ornamental lamp in accordance with another preferred embodiment of the present invention.

### DETAILED DESCRIPTION OF THE INVENTION

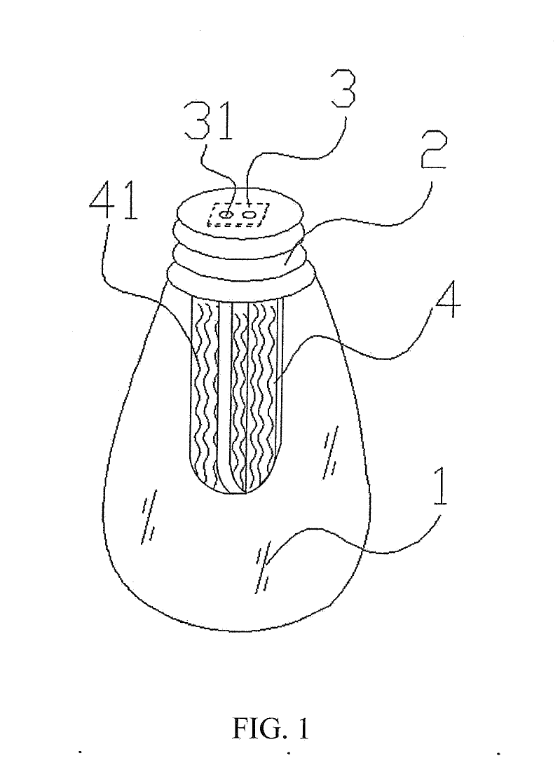

Referring to the drawings and initially to FIG. 1, an ornamental lamp in accordance with the preferred embodiment of the present invention comprises a bulb 1, a base 2 securely connected with the bulb 1 to form a hollow housing, a PCB 3 secured in the base 2, at least one LED 31 electrically connected with the PCB 3, a stem 4 securely connected with the PCB 3.

The PCB 3 is located under the at least one LED 31. The at least one LED 31 is mounted on the PCB 3. Preferably, the ornamental lamp comprises multiple LEDs 31. The stem 4 is received in the bulb 1 and is provided with a plurality of stripes 41. Preferably, the stem 4 is made of transparent material. Alternatively, the stem 4 is made of plastic material. Alternatively, the stem 4 is made of colorful transparent material. Preferably, the stem 4 has a sheet shape. Preferably, the stem 4 is a cross-shaped column. Alternatively, the stem 4 is a multi-prismatic column.

In operation, when an electric power of a power supply, such as a battery or other low-pressure electric source, is connected to the at least one LED 31, the at least one LED 31 is energized and emit light beams which are projected onto the stem 4, so that the stem 4 made of transparent material presents a lighting effect to the user. At this time, the stripes 41 on the stem 4 break the smooth surface of the stem 4 and change the reflectivity of the light beams when the light beams pass through the stripes 41 of the stem 4, so that the light beams from the stripes 41 of the stem 4 present the effect of multiple metallic strips so as to simulate the ornamental function of the tungsten filament.

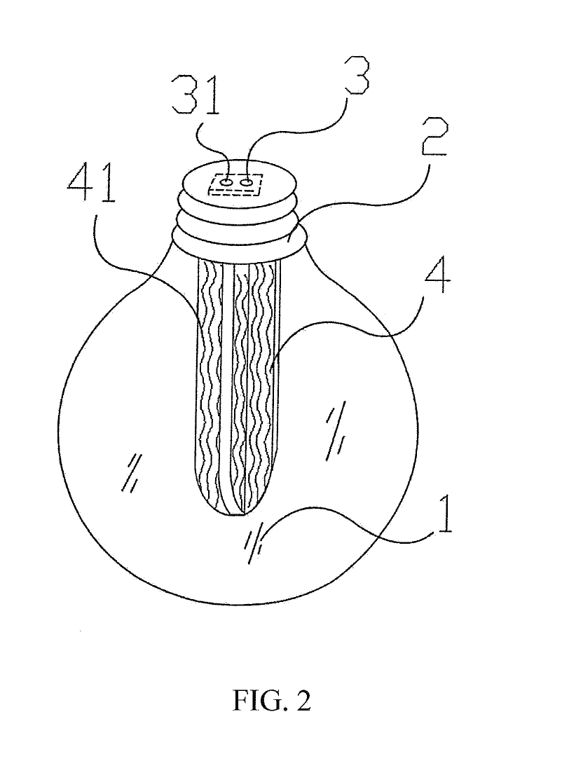

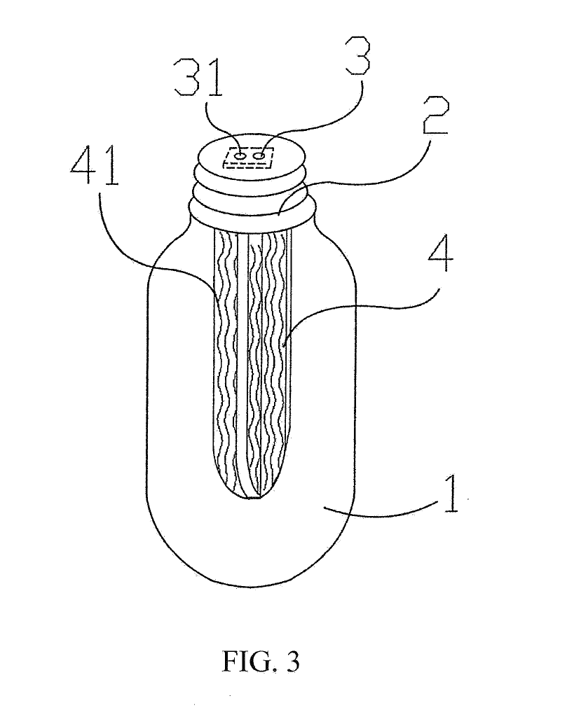

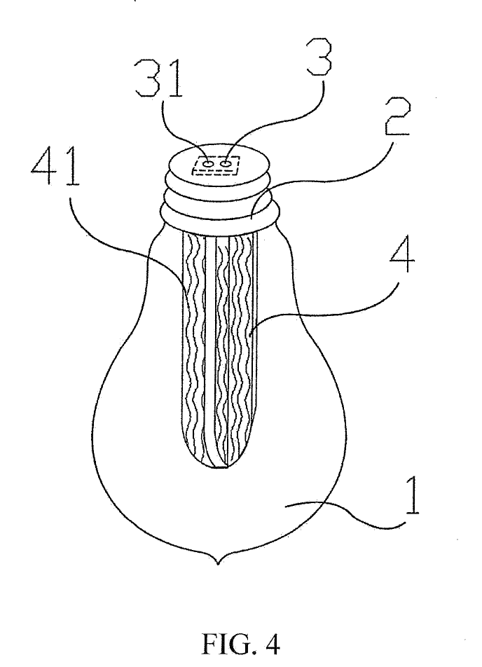

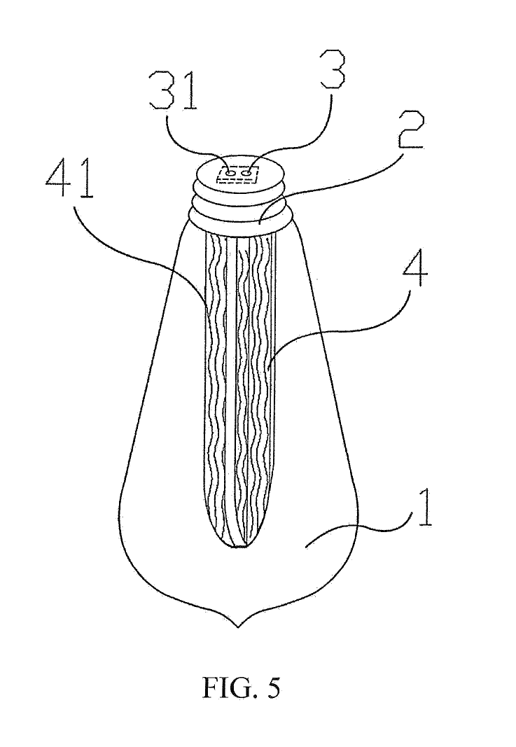

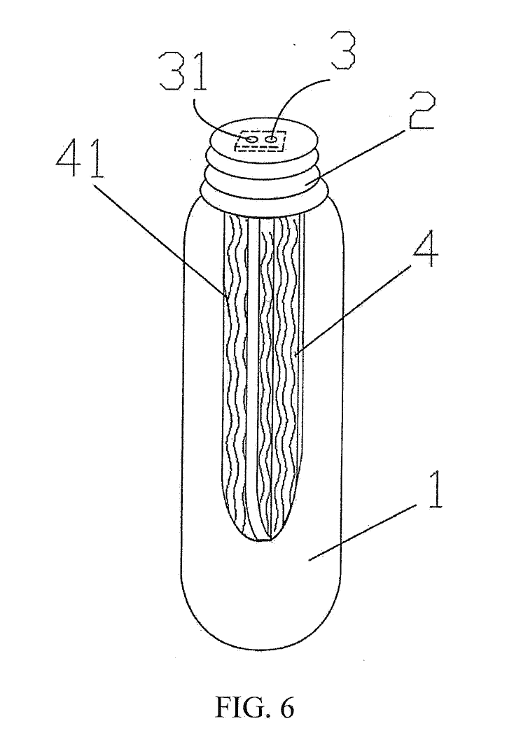

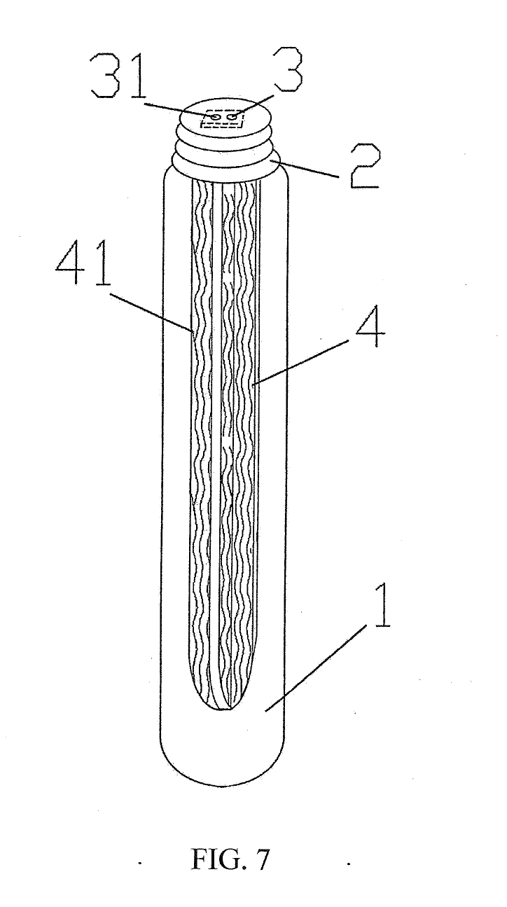

As shown in FIGS. 2-7, the ornamental lamp has different shapes.

Accordingly, the ornamental lamp supplies a cold light source with little electric power so that the ornamental lamp is operated safely and can reduce consumption of energy. In addition, the stem 4 is made of transparent material with a photoconductive feature, and the stripes 41 of the stem 4 have different reflectivity to simulate the ornamental effect of the tungsten filament, thereby enhancing the aesthetic quality of the ornamental lamp, and thereby decreasing the cost of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An ornamental lamp comprising:
a bulb;
a base securely connected with the bulb to form a hollow housing;
a PCB secured in the base;
at least one LED mounted on and electrically connected with the PCB; and
a stem securely connected with the PCB;
wherein:
the PCB is located under the at least one LED; and
the stem is provided with a plurality of stripes.

2. The ornamental lamp of claim 1, wherein the stern is made of transparent material.

3. The ornamental lamp of claim 1, wherein the stem is made of plastic material.

4. The ornamental lamp of claim 1, wherein the stem is made of colorful transparent material.

5. The ornamental lamp of claim 1, wherein the stem has a sheet shape.

6. The ornamental lamp of claim 1, wherein the stem is a cross-shaped column.

7. The ornamental lamp of claim 1, wherein the stem is a multi-prismatic column.

8. The ornamental lamp of claim 1, wherein the ornamental lamp comprises multiple LEDs.
